(19) United States
(12) Patent Application Publication
(10) Pub. No.: US 2026/0250107 A1
(43) Pub. Date: Aug. 27, 2026

(54) PULLEY THAT CAN SLIDE ON WEBBING

(71) Applicant: Taizhou Sen Kang Protective Equipment Factory, Taizhou (CN)

(72) Inventor: SENKANG CAO, Taizhou (CN)

(21) Appl. No.: 19/063,620

(22) Filed: Feb. 26, 2025

(51) Int. Cl. B66D 3/04

(52) U.S. Cl. CPC B66D 3/04

(57) ABSTRACT

The present invention belongs to the technical field of webbing pulleys, and discloses a pulley that can slide on a webbing, comprising a sliding frame, the sliding frame being provided with bearing positioning holes, and a pulley structure being mounted in the bearing positioning holes provided on the sliding frame. In the present invention, by providing a plurality of anti-slip grooves on the pulley, friction on the pulley and the webbing is increased, so as to prevent significant lateral movement of the webbing on the pulley and to prevent bending of the webbing. In the present invention, by providing hanging slots on the sliding frame and connecting hooks to the hanging slots, a hook replacement function is achieved, thereby solving the problem that a conventional webbing pulley is integrally connected to hooks, resulting in the entire pulley being unusable once the hooks are damaged.

### TECHNICAL FIELD

The present invention relates to the technical field of webbing pulleys, and specifically to a pulley that can slide on a webbing.

### BACKGROUND

Webbings are narrow-width fabrics or tubular fabrics made from various yarns. There is a wide variety of webbing fabrics, which are widely used in various industrial sectors such as apparel, footwear, bags, industry, agriculture, military supplies, transportation, etc. In the 1930s, webbings were all produced in handicraft workshops, and raw materials were cotton and hemp threads. After the founding of the People's Republic of China, raw materials for webbings have gradually developed into nylon, vinylon, polyester, polypropylene, spandex, viscose, etc., forming three major process technologies: weaving, braiding and knitting. Fabric structures include plain, twill, satin, jacquard, double-layer, multi-layer, tubular, and combined weaves.

A pulley at an upper portion of a webbing is generally used for sliding on the webbing due to height differences and is prone to causing the webbing to move on the pulley during high-speed sliding, resulting in the webbing being bent and overlapped and a sliding frame being stuck on the webbing. A conventional webbing pulley is integrally connected to hooks, resulting in the entire pulley being unusable once the hooks are damaged. Therefore, a pulley that can slide on a webbing is urgently needed to solve the above problems.

### SUMMARY

The object of the present invention is to provide a pulley that can slide on a webbing, so as to solve the problem, as proposed in the above background, that a pulley at an upper portion of a webbing is generally used for sliding on the webbing due to height differences and is prone to causing the webbing to move on the pulley during high-speed sliding, resulting in the webbing being bent and overlapped and a sliding frame being stuck on the webbing.

In order to achieve the above object, the present invention provides the following technical solution: a pulley that can slide on a webbing, comprising a sliding frame. The sliding frame is provided with bearing positioning holes. A pulley structure is mounted in the bearing positioning holes of the sliding frame. A limiting structure is mounted on an inner wall surface of the sliding frame.

Preferably, the pulley structure comprises: two auxiliary bearings, a fixing shaft and a pulley.

The two auxiliary bearings are respectively mounted in the bearing positioning holes provided on the sliding frame. The fixing shaft is mounted on inner wall surfaces of the two auxiliary bearings, and two ends of the fixing shaft pass through the two auxiliary bearings and are rotatably connected to the sliding frame. The pulley is sleeved on an outer wall surface of the fixing shaft.

Preferably, an outer wall surface of the sliding frame is coated with an anti-scratch paint.

Preferably, the sliding frame is provided with a plurality of limiting slots.

Preferably, the outer wall surface of the sliding frame is provided with two hanging slots.

Preferably, an outer wall surface of the pulley is provided with a plurality of anti-slip grooves.

Preferably, an inner side of the pulley is a hollow structure, and the inner side of the pulley is provided with a plurality of integrally formed reinforcing ribs.

Preferably, two ends of the pulley are provided with symmetrical limiting rings B. Side surfaces of the limiting rings B are integrally provided with limiting rings A. The limiting rings B and the limiting rings A are all sleeved on an outer side of the fixing shaft. The limiting rings A and the limiting rings B are respectively attached to outer walls of the pulley and the sliding frame.

Preferably, a hanging structure is arranged at the bottom of the sliding frame, and the hanging structure comprises a locking pin, a supporting frame, and a keel frame.

Two ends of the locking pin pass through. Two symmetrical fixing caps are sleeved on the two ends of the locking pin. The fixing caps are sleeved on an outer side of the locking pin to be threadedly connected to the locking pin, and the top of the supporting frame is sleeved on the outer side of the locking pin. The keel frame is fixed at the bottom of the supporting frame. Two ends of the keel frame are provided with two symmetrical handles. The handles are integrally fixed to the keel frame, and anti-slip sleeves are sleeved on outer sides of the handles. The two ends of the keel frame are provided with two symmetrical straps.

The keel frame and the handles are made of carbon fiber composite materials, and have the characteristic of being extremely lightweight. A user holds the handles with both hands, the straps are then tied to the body of the user for secondary insurance, and the locking pin is removable to facilitate maintenance and replacement of various parts.

It can be seen from the accompanying drawings of the specification that during a specific implementation, the pulley structure comprises: two auxiliary bearings, a fixing shaft and a pulley; and the two auxiliary bearings are respectively mounted in the bearing positioning holes provided on the sliding frame, the fixing shaft is mounted on the inner wall surfaces of the two auxiliary bearings, the pulley is sleeved on the outer wall surface of the fixing shaft, and the outer wall surface of the pulley is provided with the plurality of anti-slip grooves.

In the present embodiment, the sliding frame is used for fixing the two auxiliary bearings. An operator hangs goods on the two hanging slots by means of hooks. The plurality of limiting slots can better perform a connection operation on the goods at the bottom of the sliding frame, and can better perform binding and limiting operations on the goods at the bottom. Due to gravity, the goods drive the sliding frame to slide downwards along the webbing. During this period, friction is generated between the pulley and the webbing to drive the fixing shaft to rotate around the two auxiliary bearings. The plurality of anti-slip grooves increase the friction on the pulley and the webbing, so as to prevent significant lateral movement of the webbing on the pulley.

Compared with the prior art, the present invention has the beneficial effects as follows:
1. In the present invention, by providing the plurality of anti-slip grooves on the pulley, the friction on the pulley and the webbing is increased, so as to prevent significant lateral movement of the webbing on the pulley and to prevent bending of the webbing, thereby solving the problem that a pulley at an upper portion of a webbing is generally used for sliding on the webbing due to height differences and is prone to causing the webbing to move on the pulley during high-speed sliding, resulting in the webbing to be bent and overlapped and a sliding frame being stuck on the webbing.
2. In the present invention, by providing the hanging slots on the sliding frame and connecting the hooks to the hanging slots, a hook replacement function is achieved, thereby solving the problem that a conventional webbing pulley is integrally connected to hooks, resulting in the entire pulley being unusable once the hooks are damaged.

### BRIEF DESCRIPTION OF DRAWINGS

FIG. 1 is a schematic diagram of a three-dimensional structure of the present invention;

FIG. 2 is a schematic diagram of a cross-sectional structure of the present invention;

FIG. 3 is a schematic diagram of an exploded partial structure of the present invention;

FIG. 4 is a schematic diagram of a three-dimensional structure of the present invention.

In the drawings: 100, sliding frame; 200, auxiliary bearing; 300, fixing shaft; 400, pulley; 401, reinforcing rib; 500, limiting slot; 600, hanging slot; 700, anti-slip groove; 800, limiting ring A; 801, limiting ring B; 900, locking pin; 901, fixing cap; 902, supporting frame; 903, keel frame; 904, handle; 905, strap.

### DESCRIPTION OF EMBODIMENTS

The technical solutions in embodiments of the present invention will be described clearly and completely below in conjunction with the accompanying drawings in the embodiments of the present invention. Obviously, the described embodiments are only a part of embodiments of the present invention, but not all of them. On the basis of the embodiments of the present invention, all other embodiments obtained by those of ordinary skill in the art without involving any inventive effort should fall within the scope of protection of the present invention.

In the description of the present invention, it should be noted that orientation or position relationships indicated by terms “vertical”, “upper”, “lower”, “horizontal”, etc., are based on the orientation or position relationships shown in the accompanying drawings and are merely to facilitate the description of the present invention and simplify the description, rather than indicating or implying that a device or an element referred to must have a specific orientation or be constructed and operated in a specific orientation, and therefore cannot be understood as a limitation to the present invention.

In the description of the present invention, it should also be noted that, unless otherwise clearly specified and defined, terms “arrange”, “mount”, “communicate” and “connect” should be understood in a generalized manner, for example, may be a fixed connection, a detachable connection, or an integral connection; may be a mechanical connection or an electrical connection; and may be a direct connection, an indirect connection via an intermediate medium, or an internal communication between two elements. For persons of ordinary skill in the art, the above terms may be understood to have specific meanings in the present invention according to specific circumstances.

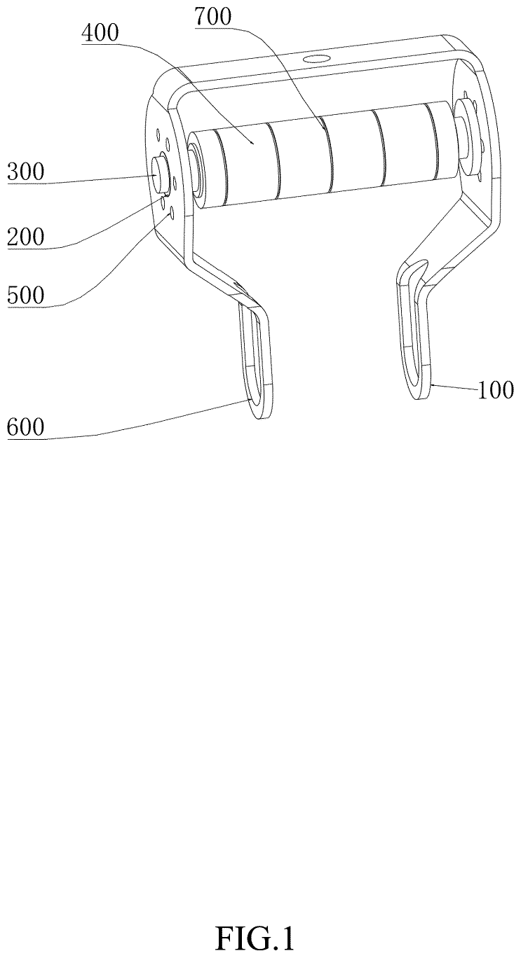

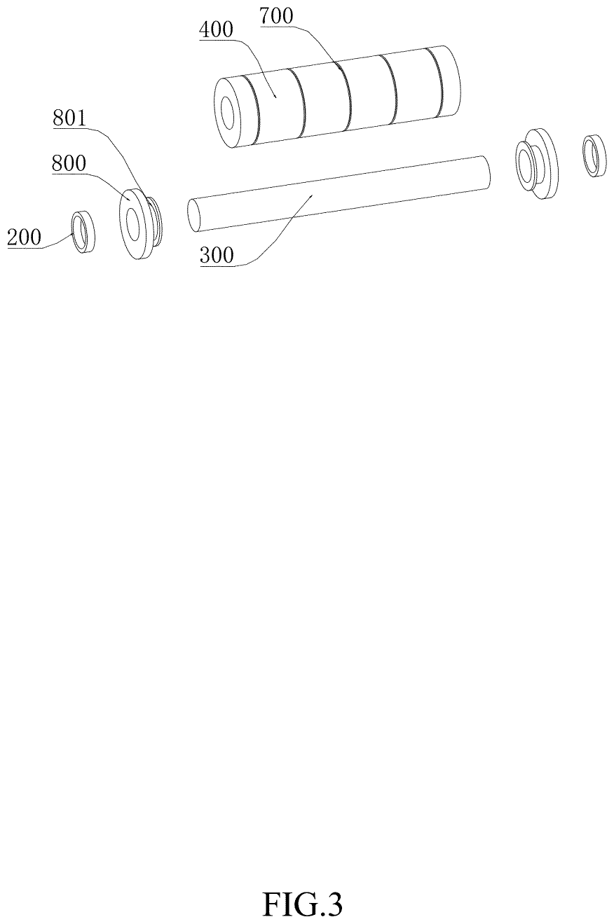

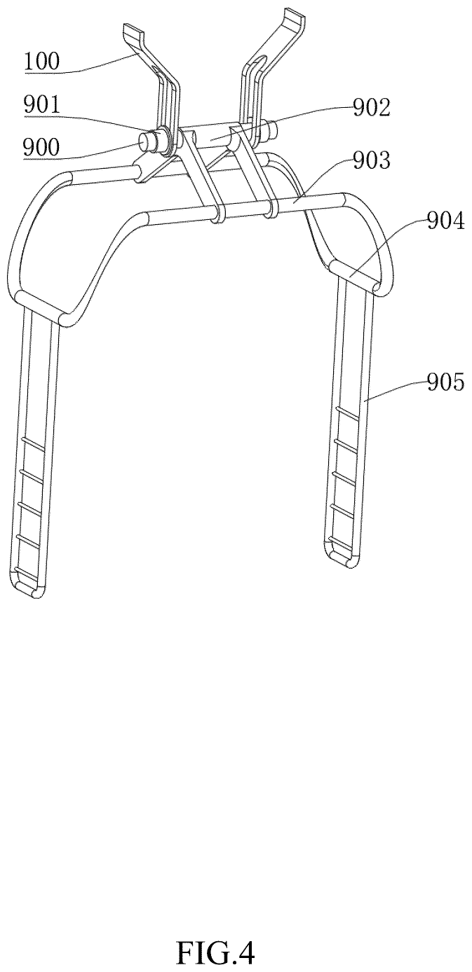

Referring to FIGS. 1-4, the present invention provides a technical solution: a pulley that can slide on a webbing, comprising a sliding frame 100. The sliding frame 100 is provided with bearing positioning holes. A pulley structure is mounted in the bearing positioning holes of the sliding frame 100. A limiting structure is mounted on an inner wall surface of the sliding frame 100.

Furthermore, the pulley structure comprises: two auxiliary bearings 200, a fixing shaft 300 and a pulley 400.

The two auxiliary bearings 200 are respectively mounted in the bearing positioning holes provided on the sliding frame 100. The fixing shaft 300 is mounted on inner wall surfaces of the two auxiliary bearings 200, and two ends of the fixing shaft 300 pass through the two auxiliary bearings 200 and are rotatably connected to the sliding frame 100. The pulley 400 is sleeved on an outer wall surface of the fixing shaft 300.

Furthermore, an outer wall surface of the sliding frame 100 is coated with an anti-scratch paint.

Furthermore, the sliding frame 100 is provided with a plurality of limiting slots 500.

Furthermore, the outer wall surface of the sliding frame 100 is provided with two hanging slots 600.

Furthermore, an outer wall surface of the pulley 400 is provided with a plurality of anti-slip grooves 700.

Furthermore, an inner side of the pulley 400 is a hollow structure, and the inner side of the pulley 400 is provided with a plurality of integrally formed reinforcing ribs 401.

Furthermore, two ends of the pulley 400 are provided with symmetrical limiting rings B 801. Side surfaces of the limiting rings B 801 are integrally provided with limiting rings A 800. The limiting rings B 801 and the limiting rings A 800 are all sleeved on an outer side of the fixing shaft 300. The limiting rings A 800 and the limiting rings B 801 are respectively attached to outer walls of the pulley 400 and the sliding frame 100. The pulley 400 is sleeved on the outer side of the fixing shaft 300 and is rotatably connected to the fixing shaft. Therefore, the pulley 400 can rotate when being in friction with the webbing, so as to cause the pulley 400 to move along the webbing.

Furthermore, a hanging structure is arranged at the bottom of the sliding frame 100, and the hanging structure comprises a locking pin 900, a supporting frame 902, and a keel frame 903.

Two ends of the locking pin 900 pass through 600. Two symmetrical fixing caps 901 are sleeved on the two ends of the locking pin 900. The fixing caps 901 are sleeved on an outer side of the locking pin 900 to be threadedly connected to the locking pin, and the top of the supporting frame 902 is sleeved on the outer side of the locking pin 900. The keel frame 903 is fixed at the bottom of the supporting frame 902. Two ends of the keel frame 903 are provided with two symmetrical handles 904. The handles 904 are integrally fixed to the keel frame 903, and anti-slip sleeves are sleeved on outer sides of the handles 904. The two ends of the keel frame 903 are provided with two symmetrical straps 905.

The keel frame 903 and the handles 904 are made of carbon fiber composite materials, and have the characteristic of being extremely lightweight. A user holds the handles 904 with both hands, the straps 905 are then tied to the body of the user for secondary insurance, and the locking pin 900 is removable to facilitate maintenance and replacement of various parts.

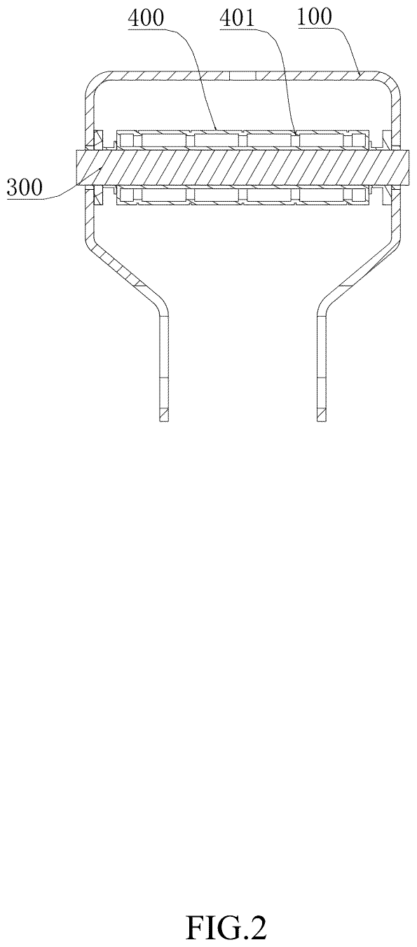

It can be seen from FIG. 2 of the specification that during a specific implementation, the pulley structure comprises: two auxiliary bearings 200, a fixing shaft 300 and a pulley 400; and the two auxiliary bearings 200 are respectively mounted in the bearing positioning holes provided on the sliding frame 100, the fixing shaft 300 is mounted on the inner wall surfaces of the two auxiliary bearings 200, the pulley 400 is sleeved on the outer wall surface of the fixing shaft 300, and the outer wall surface of the pulley 400 is provided with the plurality of anti-slip grooves 700.

In the present embodiment, the sliding frame 100 is used for fixing the two auxiliary bearings 200. An operator hangs goods on the two hanging slots 600 by means of hooks. The plurality of limiting slots 500 can better perform a connection operation on the goods at the bottom of the sliding frame 100, and can better perform binding and limiting operations on the goods at the bottom. Due to gravity, the goods drive the sliding frame 100 to slide downwards along the webbing. During this period, friction is generated between the pulley 400 and the webbing to drive the fixing shaft 300 to rotate around the two auxiliary bearings 200. The plurality of anti-slip grooves 700 increase the friction on the pulley 400 and the webbing, so as to prevent significant lateral movement of the webbing on the pulley 400.

Although the embodiments of the present invention are shown and described, it is understandable that those of ordinary skill in the art can make various changes, amendments, substitutions and modifications to these embodiments without departing from the principle and the spirit of the present invention, and the scope of the present invention is defined by the appended claims and equivalents thereof.

What is claimed is:

1. A pulley that can slide on a webbing, comprising a sliding frame (100), wherein the sliding frame (100) is provided with bearing positioning holes, a pulley structure is mounted in the bearing positioning holes provided on the sliding frame (100), and a limiting structure is mounted on an inner wall surface of the sliding frame (100).

2. The pulley that can slide on a webbing according to claim 1, wherein the pulley structure comprises: two auxiliary bearings (200), a fixing shaft (300) and a pulley (400); and
the two auxiliary bearings (200) are respectively mounted in the bearing positioning holes provided on the sliding frame (100), the fixing shaft (300) is mounted on inner wall surfaces of the two auxiliary bearings (200), two ends of the fixing shaft (300) pass through the two auxiliary bearings (200) to be rotatably connected to the sliding frame (100), and the pulley (400) is sleeved on an outer wall surface of the fixing shaft (300).

3. The pulley that can slide on a webbing according to claim 1, wherein an outer wall surface of the sliding frame (100) is coated with an anti-scratch paint.

4. The pulley that can slide on a webbing according to claim 1, wherein the sliding frame (100) is provided with a plurality of limiting slots (500).

5. The pulley that can slide on a webbing according to claim 1, wherein the outer wall surface of the sliding frame (100) is provided with two hanging slots (600).

6. The pulley that can slide on a webbing according to claim 2, wherein an outer wall surface of the pulley (400) is provided with a plurality of anti-slip grooves (700).

7. The pulley that can slide on a webbing according to claim 2, wherein an inner side of the pulley (400) is a hollow structure, and the inner side of the pulley (400) is provided with a plurality of integrally formed reinforcing ribs (401).

8. The pulley that can slide on a webbing according to claim 2, wherein two ends of the pulley (400) are provided with symmetrical limiting rings B (801), side surfaces of the limiting rings B (801) are integrally provided with limiting rings A (800), the limiting rings B (801) and the limiting rings A (800) are all sleeved on an outer side of the fixing shaft (300), and the limiting rings A (800) and the limiting rings B (801) are respectively attached to outer walls of the pulley (400) and the sliding frame (100).

9. The pulley that can slide on a webbing according to claim 1, wherein a hanging structure is arranged at the bottom of the sliding frame (100), and the hanging structure comprises a locking pin (900), a supporting frame (902), and a keel frame (903);
two ends of the locking pin (900) pass through (600), two symmetrical fixing caps (901) are sleeved on two ends of the locking pin (900), the fixing caps (901) are sleeved on an outer side of the locking pin (900) to be threadedly connected to the locking pin, the top of the supporting frame (902) is sleeved on the outer side of the locking pin (900), the keel frame (903) is fixed at the bottom of the supporting frame (902), two ends of the keel frame (903) are provided with two symmetrical handles (904), the handles (904) are integrally fixed to the keel frame (903), anti-slip sleeves are sleeved on outer sides of the handles (904), and the two ends of the keel frame (903) are provided with two symmetrical straps (905); and
the keel frame (903) and the handles (904) are made of carbon fiber composite materials, and have the characteristic of being extremely lightweight, a user holds the handles (904) with both hands, the straps (905) are then tied to the body of the user for secondary insurance, and the locking pin (900) is removable to facilitate maintenance and replacement of various parts.
